(19) United States
(12) Patent Application Publication
(10) Pub. No.: US 2005/0195897 A1
(43) Pub. Date: Sep. 8, 2005

(54) Scalable video coding method supporting variable GOP size and scalable video encoder

(75) Inventor: Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/069,565

(22) Filed: Mar. 2, 2005

Related U.S. Application Data
(60) Provisional application No. 60/550,312, filed on Mar. 8, 2004.

(30) Foreign Application Priority Data
Apr. 24, 2004 (KR) 10-2004-0028485

(51) Int. Cl. H04N 7/12

(52) U.S. Cl. 375/240.12; 375/240.01

(57) ABSTRACT

A video coding method supporting a variable group of pictures (GOP) size, a video encoder, and the structure of an encoded bitstream are provided. The coding method includes receiving a video sequence, and encoding the received video sequence into a bitstream with a variable GOP size. The video encoder includes a determiner determining a GOP size variably according to a predetermined criterion, and a scalable video coding unit encoding an input video sequence into a bitstream with the determined GOP size.

This application claims priority from Korean Patent Application No. 10-2004-0028485 filed on Apr. 24, 2004, in the Korean Intellectual Property Office and U.S. Provisional Patent Application No. 60/550,312 filed on Mar. 8, 2004, in the United States Patent and Trademark Office, the entire disclosures of which are incorporated herein by reference in their entirety.

### BACKGROUND OF THE INVENTION

1. Field of the Invention

The present invention relates to video compression, and more particularly, to a video coding method supporting a variable GOP size, a video encoder, and the structure of an encoded bitstream.

2. Description of the Related Art

With the development of information communication technology including the Internet, a variety of communication services have been newly proposed. One among such communication services is a Video On Demand (VOD) service. Video on demand refers to a service in which a video content such as movies or news is provided to an end user over a telephone line, cable or Internet upon the user's request. Users are allowed to view a movie without having to leave their residence. Also, users are allowed to access various types of knowledge via moving image lectures without having to go to school or private educational institutes.

Various requirements must be satisfied to implement such a VOD service, including wideband communications and motion picture compression to transmit and receive a large amount of data. Specifically, moving image compression enables VOD by effectively reducing bandwidths required for data transmission. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required to provide a VOD service. When a 90-minute movie based on such an image is stored, a storage space of about 1200 Gbits is required. Accordingly, since uncompressed moving images require a tremendous bandwidth and a large capacity of storage media for transmission, a compression coding method is a requisite for providing the VOD service under current network environments.

A basic principle of data compression is removing data redundancy. Motion picture compression can be effectively performed when the same color or object is repeated in an image, or when there is little change between adjacent frames in a moving image.

Known video coding algorithms for motion picture compression include Moving Picture Experts Group (MPEG)-1, MPEG-2, H.263, and H.264 (or AVC). In such video coding methods, temporal redundancy is removed by motion compensation based on motion estimation and compensation, and spatial redundancy is removed by Discrete Cosine Transformation (DCT). These methods have high compression rates, but they do not have satisfactory scalability since they use a recursive approach in a main algorithm. In recent years, research into data coding methods having scalability, such as wavelet video coding and Motion Compensated Temporal Filtering (MCTF), has been actively carried out. Scalability indicates the ability to partially decode a single compressed bitstream at different quality levels, resolutions, or frame rates.

FIG. 1 is a block diagram of a conventional scalable video encoder.

Referring to FIG. 1, the conventional scalable video encoder receives a plurality of frames constituting a video sequence and performs compression to generate a bitstream. To achieve this function, the scalable video encoder includes a temporal transformer 110 removing temporal redundancies present in a plurality of frames, a spatial transformer 120 removing spatial redundancies in the frames from which the temporal redundancies have been removed, a quantizer 130 quantizing transform coefficients created by removing the temporal and spatial redundancies, and a bitstream generator 140 generating a bitstream including the quantized transform coefficients and other information.

The temporal transform unit 110 includes a motion estimator 112 and a temporal filter 114 in order to perform temporal filtering by compensating for motion between frames. The motion estimator 112 calculates a motion vector between each block in a current frame being subjected to temporal filtering and its counterpart in a referred frame. The temporal filter 114 that receives information about the motion vectors performs temporal filtering on the plurality of frames using the received information.

A spatial transform unit 120 uses a wavelet transform to remove spatial redundancies from the frames from which the temporal redundancies have been removed, i.e., temporally filtered frames. The spatial transform unit 120 removes spatial redundancies from the frames using a wavelet transform. In a currently known wavelet transform, a frame is decomposed into four sections (quadrants). A quarter-sized image (L image), which is substantially the same as the entire image, appears in a quadrant of the frame, and information (H image), which is needed to reconstruct the entire image from the L image, appears in the other three quadrants. In the same way, the L image may be decomposed into a quarter-sized LL image and information needed to reconstruct the L image.

The frames (transform coefficients) from which temporal and spatial redundancies have been removed are delivered to a quantizer 130 for quantization. The quantizer 130 quantizes the real-number transform coefficients with integer-valued coefficients. That is, the quantity of bits for representing image data can be reduced through quantization. Meanwhile, the MCTF based video encoder uses an embedded quantization technique. By performing embedded quantization on transform coefficients, it is possible to not only reduce the amount of information to be transmitted but also achieve signal-to-noise ratio (SNR) scalability. The term “embedded” is used to mean that a coded bitstream involves quantization. In other words, compressed data is generated or tagged by visual importance. Embedded quantization algorithms currently in use are EZW, SPIHT, EZBC, and EBCOT.

The bitstream generator 140 generates a bitstream containing coded image data with a necessary header attached thereto, the motion vectors obtained from the motion estimator 112, and other necessary information.

FIG. 2 illustrates the basic concept of a Successive Temporal Approximation and Referencing (STAR) algorithm.

Referring to FIG. 2, all frames at each temporal level are represented by nodes and referencing between frames is indicated by arrows. Only necessary frames can be positioned at each temporal level. For example, only one of the frames in a group of pictures (GOP) appears at the highest temporal level (level 4). A frame f(0) has the highest temporal level. At the next temporal level, temporal analysis is successively performed to predict error frames having high-frequency components from original frames having indices of the previously encoded frames. When a GOP size is 8, the frame f(0) is encoded as an intraframe (I frame) at the highest temporal level (level 4), and at the next temporal level (level 3), the unencoded frame f(0) is used to encode a frame f(4) as an interframe (H frame). Then, at temporal level 2, the unencoded frames f(0) and f(4) are used to encode frames f(2) and f(6) as H frames. At the lowest temporal level (level 1), the unencoded frames f(0), f(2), f(4), and f(6) are used to encode frames f(1), f(3), f(5), and f(7) as H frames.

A decoding process begins with the frame f(0). Then, the frame f(4) is decoded using the decoded frame f(0) as a reference. In the same manner, the frames f(2) and f(6) are decoded using the previously decoded frames f(0) and f(4). Lastly, the frames f(1), f(3), f(5), and f(7) are decoded using the previously decoded frames f(0), f(2), f(4), and f(6).

In the STAR algorithm, the same temporal processing is performed both on encoder side and decoder side. Thus, video coding using the STAR algorithm achieves scalability both on the encoder side and the decoder side, unlike video coding using conventional Motion Compensate Temporal Filtering (MCTF) that maintains scalability only on the decoder side.

FIGS. 3A-C illustrate the process of obtaining temporal scalability using a conventional temporal filtering algorithm. A GOP size is 8.

To achieve temporal scalability with a bitstream encoded in a manner as shown in FIG. 2, a transcoder truncates the bitstream and sends only a necessary portion corresponding to the desired temporal level to a decoder. When the bitstream is transcoded with the full frame rate, all frames in the bitstream must be sent to the decoder.

The decoder receives one I frame and seven H frames per GOP in order to reconstruct the original video sequence as shown in FIG. 3A. More specifically, an I frame that is the first frame of the GOP is decoded first, followed by decoding of frame 5 using the decoded first frame as a reference. Similarly, frame 3 is decoded using the decoded first and fifth frames for reference, followed by decoding of frame 7 using the decoded fifth frame. Then, frames 2, 4, and 6 are decoded by referencing the previously decoded frames. When reference frames from adjacent GOPs are used, frames are decoded by referencing an I frame in the adjacent GOP as indicated by dotted arrows. That is, the frame 5 is decoded by referencing the decoded first frame in the GOP and the first frame (frame 9) in the next GOP. By performing this process, the decoder reconstructs a video sequence at temporal level 1.

To reconstruct a video sequence having a half frame rate of the video sequence at temporal level 1, as shown in FIG. 3B, the transcoder truncates frames 2, 4, 6, 8, and 10 and sends a bitstream including only frames 1, 3, 5, 7, 9, and 11 corresponding to temporal level 2 to the decoder.

In the same manner, to reconstruct a video sequence having a quarter frame rate of the video sequence at temporal level 1, as shown in FIG. 3C, the transcoder sends a bitstream including only frames 1, 5, 9, 13, and 17 corresponding to temporal level 3 to the decoder by truncating the remaining frames.

In this way, temporal scalability can be obtained. In general, more bits should be allocated to an I frame than those for an H frame. Referring to FIGS. 3A-3C, the I frame occurs every two frames at temporal level 3, every four frames at temporal level 2, and every eight frames at temporal level 1. That is, the conventional scalable video coding scheme requires a large number of bits for transmission of the same quality video since the number of I frames contained in a lower frame-rate bitstream increases. One way to solve this problem is to increase a GOP size. For example, if a GOP size is increased to 16, the I frame occurs every four frames at temporal level 3. If the GOP size is increased to 32, the I frame occurs every eight frames at temporal level 3.

Increasing the GOP size indefinitely requires a large amount of memory in scalable video encoder and decoder for encoding and decoding and reduces random accessibility. Thus, there is a need for a scalable video algorithm that variably determines the size of a GOP and efficiently encodes a video sequence into a bitstream with a variable GOP size.

### SUMMARY OF THE INVENTION

The present invention provides a scalable video coding method capable of efficiently encoding a video sequence into a bitstream with a variable GOP size.

The present invention also provides a scalable video encoder for performing the same method.

The above stated aspects as well as other aspects, features and advantages of the present invention will become clear to those skilled in the art upon review of the following description, the attached drawings and appended claims.

According to an aspect of the present invention, there is provided a scalable video coding method including the steps of receiving a video sequence and encoding the received video sequence into a bitstream with a variable GOP size.

According to another aspect of the present invention, there is provided a scalable video encoder including a determiner determining a group of pictures (GOP) size variably according to a predetermined criterion, and a scalable video coding unit encoding an input video sequence into a bitstream with the determined GOP size.

According to still another aspect of the present invention, there is provided a bitstream with variable-sized GOPs, the bitstream including video frames scalably encoded with a first group of pictures (GOP) size, and video frames scalably encoded with a GOP size different than the first GOP size.

According to a further aspect of the present invention, there is provided a transcoding method including receiving a bitstream containing scalably encoded video frames and extra frames obtained by scalably encoding original frames corresponding to encoded intraframes in the scalably encoded video frames as interframes, and selectively deleting the encoded intraframes and extra frames corresponding to the intraframes.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional scalable video encoder;

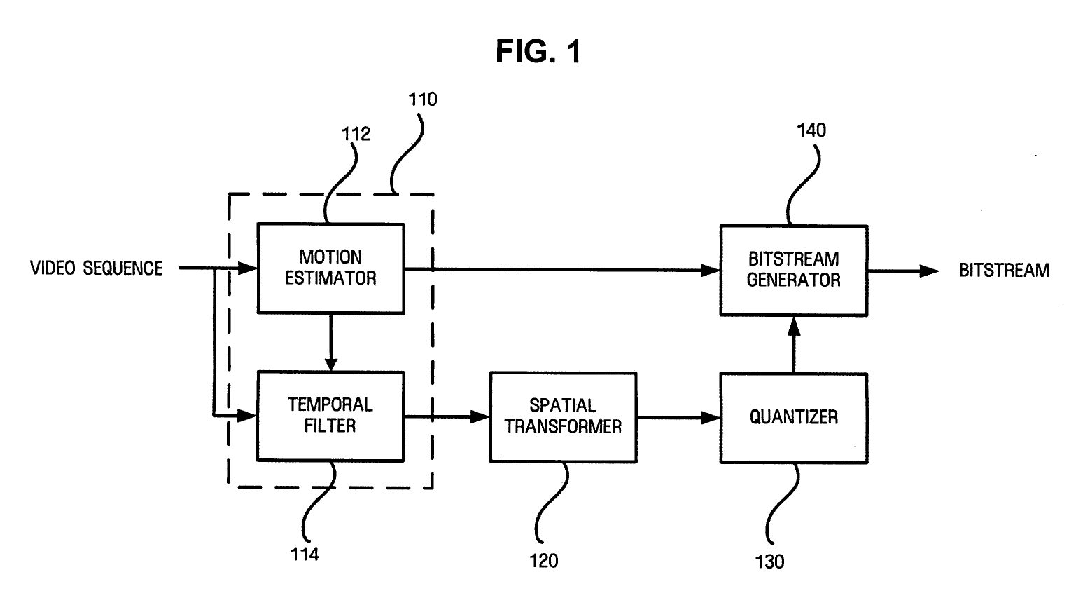

FIG. 2 shows an example of a conventional temporal filtering algorithm;

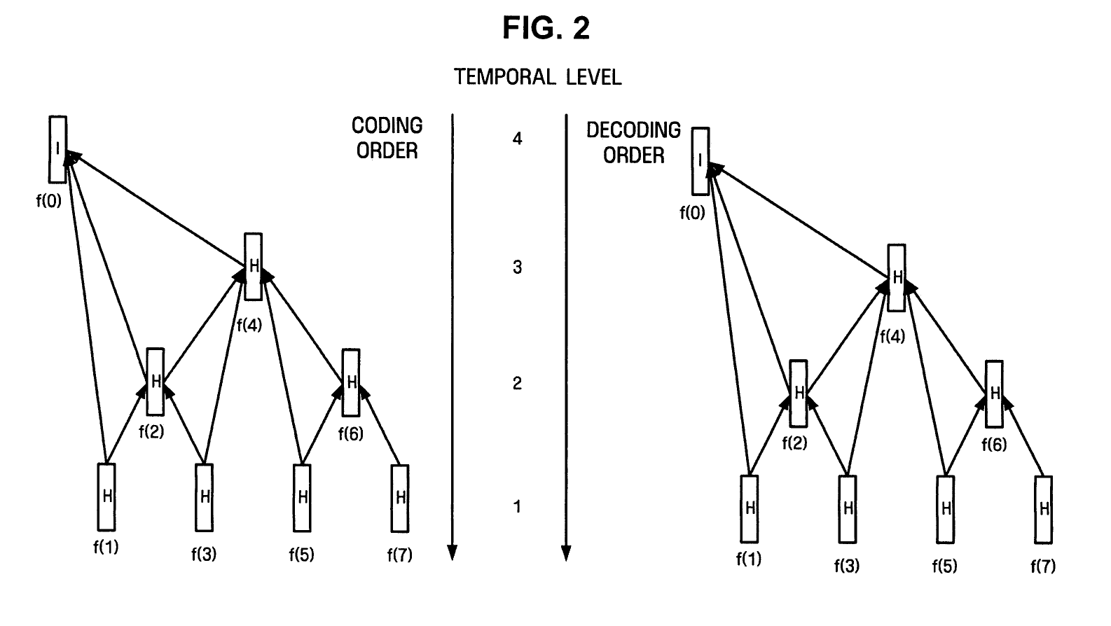

FIGS. 3A-C illustrate the process of obtaining temporal scalability in a conventional temporal filtering algorithm;

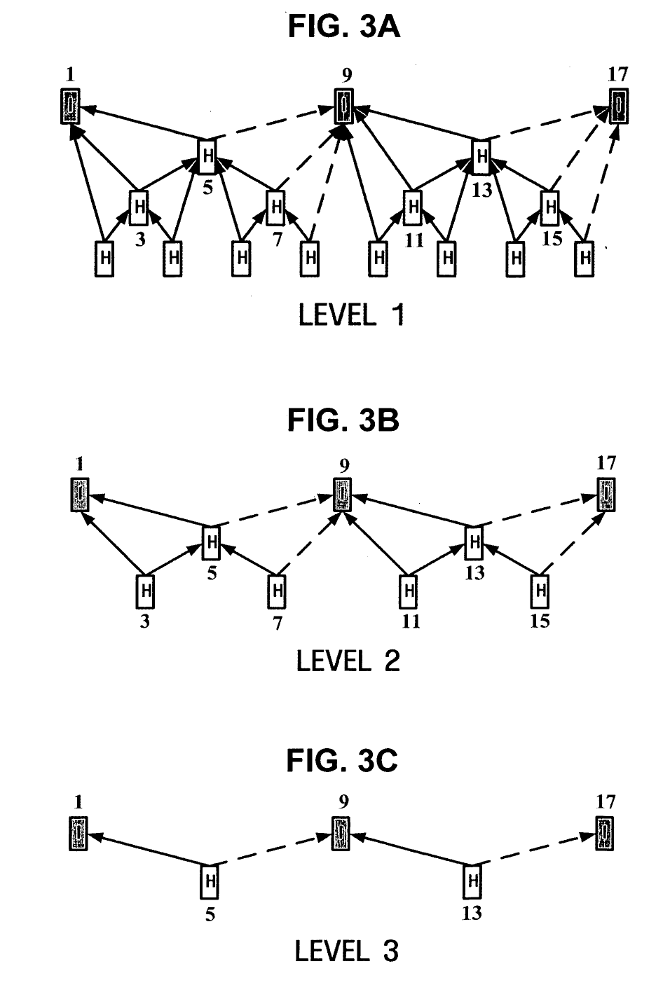

FIG. 4 illustrates the process of merging groups of pictures (GOPs) during temporal filtering according to a first embodiment of the present invention;

FIG. 5 illustrates the process of merging GOPs during temporal filtering according to a second embodiment of the present invention;

FIG. 6 illustrates the process of merging GOPs during temporal filtering according to a third embodiment of the present invention;

FIG. 7 is a block diagram of a scalable video encoder according to an embodiment of the present invention; and

FIG. 8 shows the structure of an encoded bitstream according to an embodiment of the present invention.

### DETAILED DESCRIPTION OF THE INVENTION

The present invention will now be described more fully with reference to the accompanying drawings, in which exemplary embodiments of the invention are shown.

According to the MPEG-21 standard, requirements for reconstructing video sequences shown in Table 1 from a single compressed bitstream must be met.

TABLE 1

| Spatial resolution | Frame rate | |
|---|---|---|
| 704 × 576 | 60 | Hz |
| 704 × 576 | 30 | Hz |
| 352 × 288 | 30 | Hz |
| 352 × 288 | 15 | Hz |
| 176 × 144 | 15 | Hz |
| 176 × 144 | 7.5 | Hz |

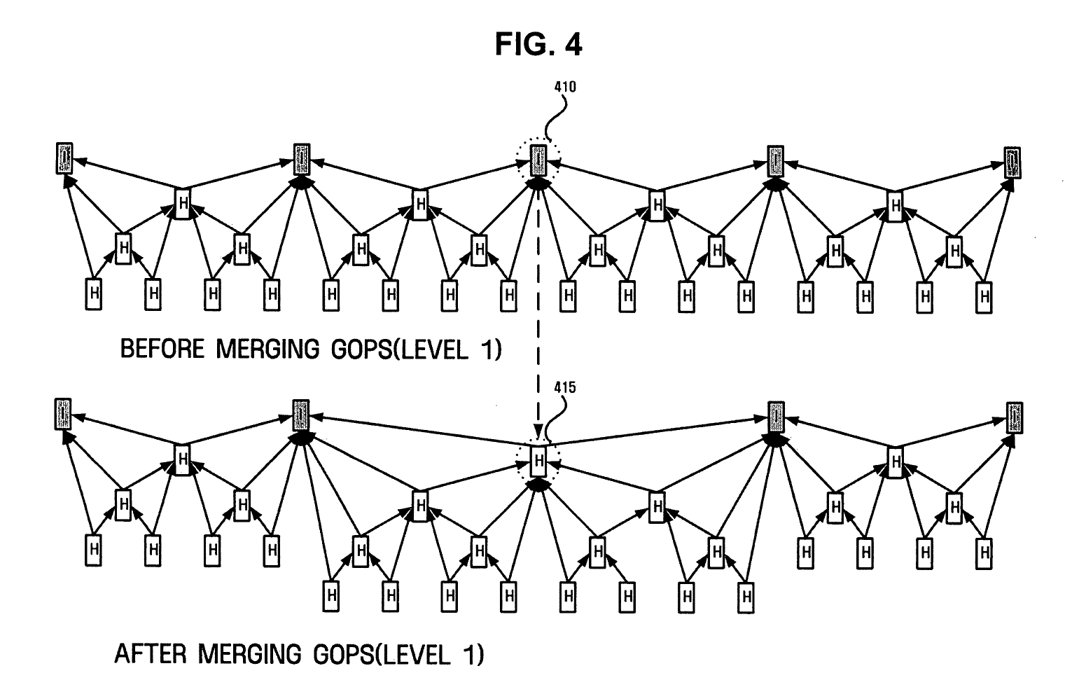

Determining a GOP size based on a high frame rate to satisfy these requirements will reduce compression efficiency for a low frame rate video. On the other hand, determining a GOP size based on a low frame rate will not only require a large amount of memory for compression or reconstruction of a high frame rate video but also reduce random accessibility. Some approaches for solving these problems will now be described with reference to FIGS. 4 through 6. For convenience of explanation, each H frame is encoded by referencing two frames.

In FIGS. 4 through 6, each block denotes a single frame, and a gray block and a white block respectively denote an I frame and an H frame. A solid arrow denotes a frame being referenced, and frames surrounded by dotted circles represent an I frame and an H frame into which the I frame is converted by merging two GOPs into one. A dotted arrow denote a direction from an I frame toward an H frame. Merging two GOPs means encoding an I frame in one GOP as an H frame using I frames in adjacent GOPs as a reference. In other words, by merging the two GOPs, either of two I frames from the two GOPs is encoded as an H frame.

FIG. 4 illustrates the process of merging GOPs into each other during temporal filtering according to a first embodiment of the present invention.

In general, encoding an H frame for a video with rapidly changing motion requires a significantly larger number of bits than for a video with less or slow motion. This is because the rapidly changing motion video requires the increased number of bits for encoding motion vectors and the increased size of a texture in an H frame. Thus, increasing a GOP size may be rather inefficient for the rapidly changing motion video. In practice, sports video footage consists of a combination of rapidly changing motions and slow motions. In order to efficiently encode a video sequence for sports video, it is desirable to variably determine an optimal GOP size. FIG. 4 illustrates the process of variably determining a GOP size.

When a motion near an I frame 410 shown in Level 1 of FIG. 4 is monotonous, the I frame 410 is encoded as an H frame 415 by merging GOPs as shown in Level 2 of FIG. 4. In this case, since the H frame 415 requires a significantly smaller number of bits for encoding than the I frame 410, merging GOPs (Level 2) improves coding efficiency compared to that obtained before merging GOPs (Level 1). Whether to merge GOPs into each other is determined by considering coding efficiencies obtained before and after merging GOPs. That is, when converting an I frame to an H frame by merging GOPs results in higher coding efficiency than before merging, a video sequence is encoded with a larger GOP size by merging the GOPs. Conversely, when this results in lower coding efficiency than before merging, a video sequence is encoded with an original GOP size without merging the GOPs.

One method for determining whether to merge GOPs is to compare cost calculated when encoding a video sequence with an original GOP size without merging the GOPs with that calculated when encoding the same with a larger GOP size by merging the GOPs. If the latter is less than the former, the video sequence is encoded with the larger GOP size by merging the GOPs. Conversely, if the former is less than the latter, the video sequence is encoded with the original GOP size available before merging the GOPs.

Another method is to compare cost calculated when encoding an I frame before merging GOPs with that calculated when encoding the I frame as an H frame after merging GOPs, instead of comparing costs for all frames in a GOP. The first method involves encoding a video sequence twice while the second method involves encoding a video sequence with an original GOP size before merging GOPs and then encoding only a frame to be converted into an H frame.

Yet another method is to compare a cost associated with an I frame with a cost associated with an H frame multiplied by a predetermined factor. For example, the cost for the I frame can be compared with the cost for the H frame multiplied by a factor of 1.1. The comparison is made in this way because the I frame is reconstructed at higher quality than the H frame. It is reasonable to merge GOPs when this can sufficiently compensate for adverse effects such as increased amount of memory and degradation of image quality. In other words, GOPs are merged into each other only when it sufficiently compensates for degradation of image quality due to conversion to an H frame by using bits saved due to merging between GOPs in improving the image quality of other frames.

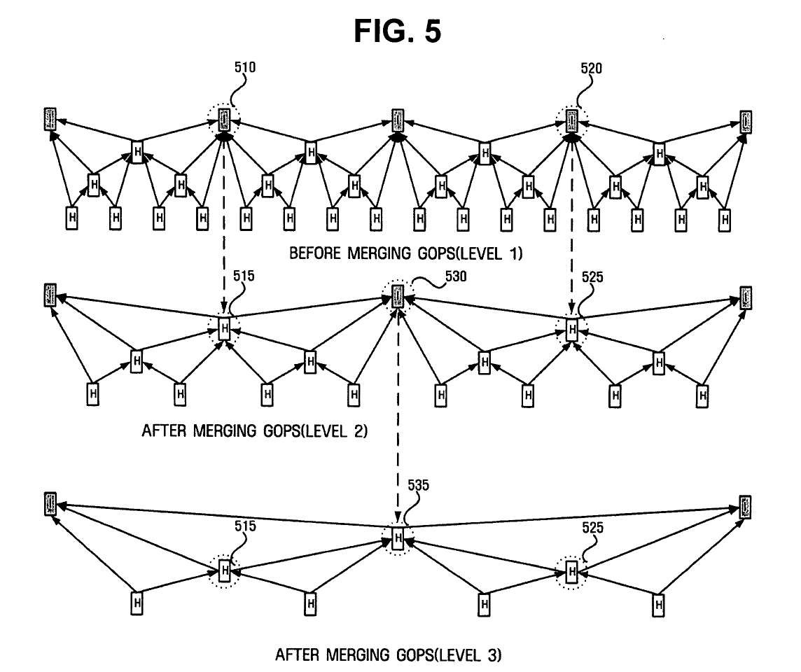

While FIG. 4 shows the process of merging GOPs at the same frame rate, FIG. 5 shows the process of merging GOPs with varying frame rates during temporal filtering according to a second embodiment of the present invention.

FIG. 5 illustrates the process of merging GOPs during temporal filtering according to a second embodiment of the present invention.

A frame rate usually decreases by half as the temporal level goes down one step. When a frame rate decreases to half of the previous rate, two GOPs are merged into a single one. That is, by alternately converting one of every two I frames in the two adjacent GOPs into an H frame, the number of I frames contained in the resultant single GOP is made equal to that contained in each GOP with the original frame rate.

Referring to Level 1 and Level 2 shown in FIG. 5, in order to obtain a bitstream of temporal level 2 having a half frame rate of a bitstream of temporal level 1, I frames are alternately converted into H frames. After converting I frames 510 and 520 to H frames 515 and 525, respectively, a bitstream of temporal level 2 including the H frames 515 and 525 is sent to a decoder. Similarly, referring to Level 3 of FIG. 5, when a frame rate decreases to quarter that of the bitstream shown in Level 1 of FIG. 5, an I frame 530 is converted into an H frame 535. By merging GOPs in this way, it is possible to obtain a bitstream with GOPs having the same structure as shown in Level 1 of FIG. 5 at temporal level 3. Thus, each GOP has a bitstream including one I frame for every 8 frames, that is, one I frame followed by seven H frames. By alternately converting I frames to H frames (merging GOPs) as the frame rate decreases by half, the second embodiment of the present invention can solve a problem with a conventional encoding method in which the number of I frames increases as a frame rate decreases. While it is described above that the number of I frames in each GOP is constant regardless of a frame rate, it may decrease as a frame rate goes down one step. For example, when the frame rate decreases by half, the number of I frames may be decreased to a third (converting two of three I frames to H frames) or quarter of the previous one or to a two-third (converting one of three I frames to an H frame) or three-quarter of the previous one. Increasing or decreasing the number of I frames (merging GOPs) with a frame rate should be construed as being included in the present invention.

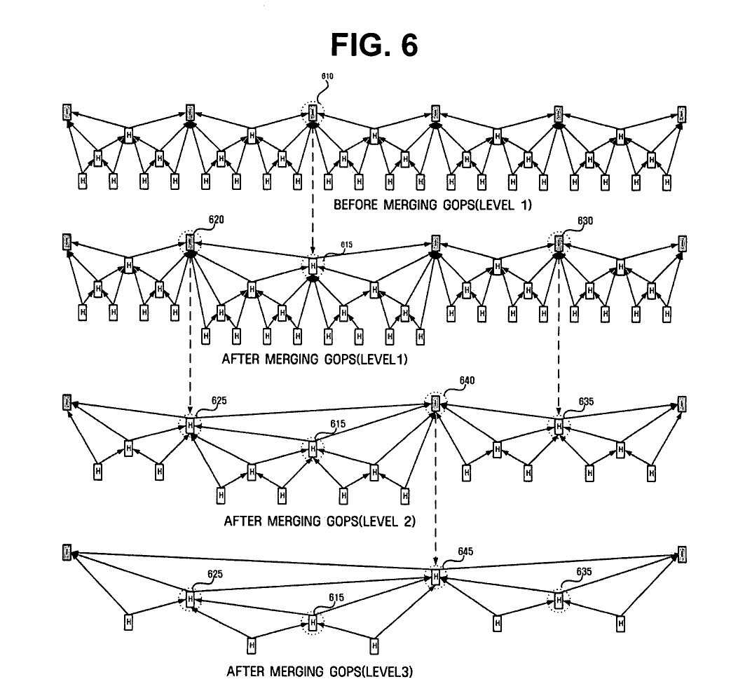

Merging GOPs at varying frame rates according to the second embodiment of the present invention can be performed independently of the merging according to the first embodiment of the present invention. That is, while the former determines whether to merge GOPs considering the characteristics of video (amount of motion), the latter determines how to merge GOPs according to a frame rate required by a decoder. FIG. 6 shows a combination of the first and second embodiments.

FIG. 6 illustrates the process of merging GOPs during temporal filtering according to a third embodiment of the present invention.

First, a bitstream of Level 2 of FIG. 6 can be obtained by merging GOPs in a bitstream of Level 1 of FIG. 6 at the same temporal level. The two GOPs are merged into one when converting an I frame 610 to an H frame 615 and this is more advantageous due to a small amount of motion or other reasons.

To obtain bitstreams of Level 3 in FIG. 6 and Level 4 in FIG. 6 with varying frame rates, I frames 620, 630, and 640 are respectively converted into H frames 625, 635, and 645.

The bitstream of Level 2 in FIG. 6 created by merging GOPs in the bitstream of Level 1 in FIG. 6 at the same temporal level includes the H frame 615 instead of the I frame 610. On the other hand, a bitstream considering varying temporal levels includes all original and converted H frames. That is, in order to send the bitstreams of Levels 3 and 4 in FIG. 6, the encoded bitstream contains the H frames 625 and 635 for temporal level 2 and the H frame 645 for temporal level 3 in addition to all frames in the bitstream of Level 2 in FIG. 6. When receiving a request for the bitstream of temporal level 2 from the decoder, the I frames 620 and 630 and the H frame 645 and frames in the lowest temporal level (even-numbered frames) are truncated in the encoded bitstream. A portion of the encoded bitstream remaining after truncating the unnecessary bits is the bitstream shown in Level 3 of FIG. 6 that is then sent to the decoder.

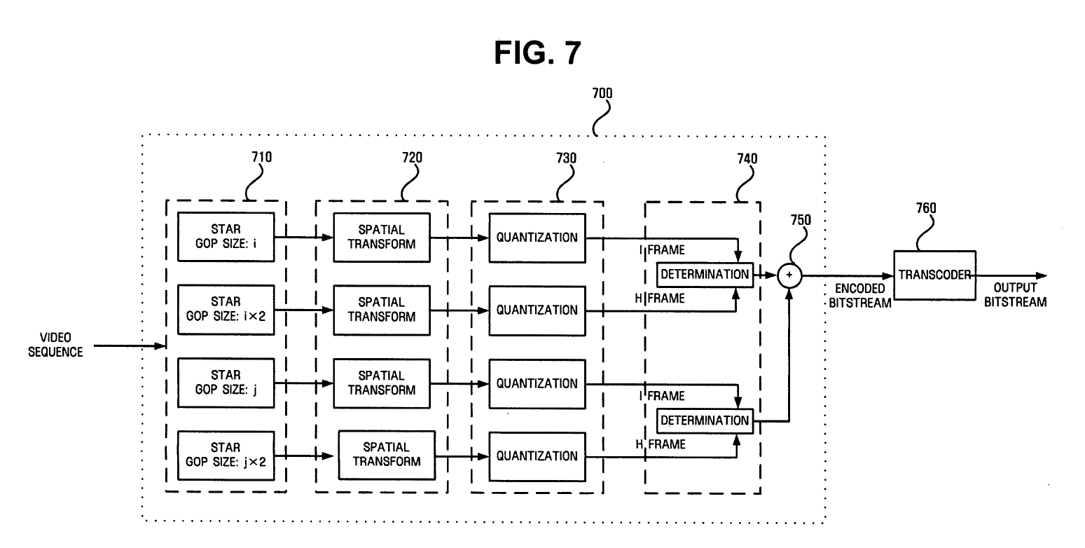

FIG. 7 is a block diagram of a scalable video encoder 700 according to an embodiment of the present invention.

The scalable video encoder 700 includes a temporal transformer 710 removing temporal redundancies between frames in a video sequence, a spatial transformer 720 removing spatial redundancies between the frames, a quantizer 730 quantizing the frames from which the temporal and spatial redundancies have been removed, a determiner 740 determining whether to merge GOPs, and a bitstream generator 750. The scalable video encoder 700 further includes an extra frame generator 770 generating H frames that will be added to the bitstream to replace I frames according to a temporal level (or frame rate).

The temporal transformer 710 removes temporal redundancies between the frames in each GOP using one I frame as a reference. In the present embodiment, the temporal transformer 710 uses a Successive Temporal Approximation and Referencing (STAR) algorithm for temporal filtering. Unconstrained Motion Compensate Temporal Filtering (UMCTF) not including the step of updating frames may be used instead of the STAR algorithm. The temporal transformer 710 removes temporal redundancies in a video sequence with a GOP size of i. Furthermore, it increases the GOP size by a factor of 2 and removes temporal redundancies in the video sequence with a GOP size of i×2.

The spatial transformer 720 removes spatial redundancies in the frames from which the temporal redundancies have been removed by the temporal transformer 710. While a scalable video coding scheme usually employs wavelet transform to remove spatial redundancies, the spatial transformer 720 may use Discrete Cosine Transform (DCT).

The quantizer 730 performs quantization on the frames (transform coefficients) from which temporal and spatial redundancies have been removed. The quantization is performed using a well-known algorithm such as Embedded Zero-Tree Wavelet (EZW), Set Partitioning in Hierarchical Trees (SPIHT), Embedded Zero Block Coding (EZBC), or Embedded Block Coding with Optimized Truncation (EBCOT).

The determiner 740 determines whether to convert an I frame in frames encoded with the quantizer 730 to an H frame. To accomplish this, the determiner 740 compares a cost calculated when encoding with the GOP size of i with that calculated when encoding with the GOP size of i×2 and selects a GOP size with less cost. For example, if the former is less than the latter, the determiner 740 generates a bitstream encoded with the GOP size of i by encoding an I frame as an I frame. Conversely, when the latter is less than the former, the determiner 740 generates a bitstream encoded with the GOP size of i×2 by encoding an I frame to be converted as an H frame.

One way of reducing the computational load is to encode only a frame being converted into an H frame with the GOP size of i×2 instead of a video sequence and compare costs between the frame encoded with the GOP size of i×2 and a corresponding I frame encoded with the GOP size of i. This is possible because an H frame is encoded using the original frame as a reference instead of a decoded frame in most scalable video coding algorithms using open-loop systems.

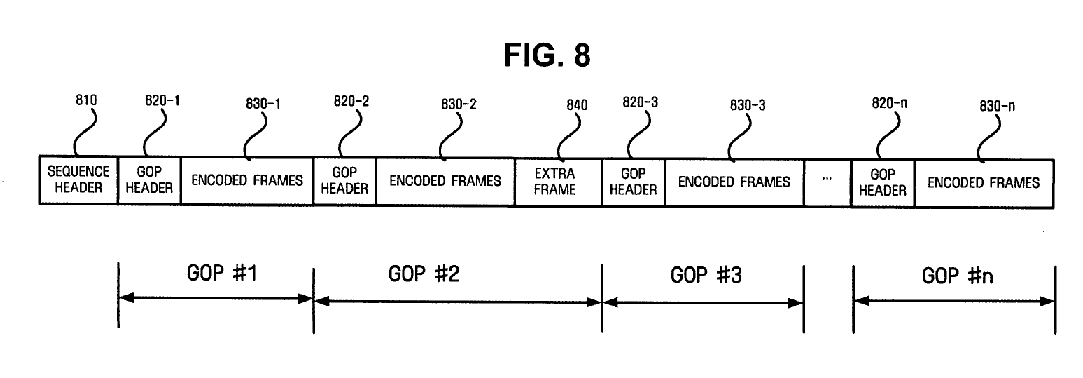

The bitstream generator 750 generates a bitstream with variable-sized GOPs, including quantized frames, motion vectors, and other necessary information. The structure of the bitstream will be described later with reference to FIG. 8. The extra frame generator 770 generates H frames (extra frames) to replace I frames as a frame rate decreases. The generated extra frame has information about a frame rate to be added and is combined into the bitstream.

The transcoder 760 truncates unnecessary bits of the encoded bitstream and creates an output bitstream including only necessary bits. For example, to produce a low frame-rate bitstream, frames at a low temporal level are truncated. For a bitstream including extra frames, the transcoder 760 checks whether an extra frame will be used for an appropriate frame rate. If the extra frame is used for the frame rate, the transcoder 760 truncates a corresponding I frame so as to leave the extra frame in the bitstream, thereby efficiently reducing the number of I frames in the bitstream. Extra frames corresponding to untruncated I frames can be truncated.

Merging GOPs at the same temporal level will now be described.

First, video coding is performed on i×2 frames in a video sequence received from the temporal transformer 710 with a GOP size of i. Then, video coding is performed on the i×2 frames with a GOP size of i×2. The determiner 740 compares costs between a second I frame encoded with the GOP size of i with a corresponding H frame encoded with the GOP size of i×2. If the cost associated with the H frame is less than that associated with the I frame, the same frame range (i×2 frames) is encoded with the GOP size of i×2. On the other hand, if the cost with the I frame is less than the other, the same frame range is encoded with the GOP size of i.

Then, video coding is performed on the next frame range by encoding i×2 frames (2 GOP) with the GOP size of i and then with the GOP size of i×2. The determiner 740 determines whether a GOP size will be set to i or i×2 after comparison between costs for the GOP sizes of i and i×2.

The above process is iteratively performed until all frames in the video sequence are encoded.

While it is described that comparison is made between costs for GOP sizes of i and i×2, the GOP size may be i×3, i×4, or i×8 instead of i×2.

Furthermore, only an H frame corresponding to a second I frame encoded with the GOP size of i may be encoded with the GOP size of i×2 instead of all i×2 frames for cost comparison.

Next, merging GOPs at varying temporal levels will be described.

In most conventional scalable video coding algorithms, as a temporal level increases, a frame rate decreases by half so the number of I frames increases by a factor of 2. That is, a bitstream of temporal level 2 is obtained by alternately removing frames from a bitstream of temporal level 1. In order to reduce the number of I frames in the bitstream of temporal level 2, GOPs are merged into each other by periodically converting an I frame into an H frame. One method of merging GOPs is to alternately convert an I frame into an H frame so that the bitstream of temporal level 2 has the same percentage of I frames as the bitstream of temporal level 1. Similarly, some of I frames are converted into H frames at temporal level 3 so that a bitstream of temporal level 3 has the same percentage of I frames as the bitstream of temporal level 1.

To accomplish frame conversion, the bitstream of temporal level 1 contains H frames to be used for merging GOPs at temporal levels 2 and 3.

More specifically, two GOPs in a video sequence are encoded with a GOP size of j, followed by encoding of a video sequence with a GOP size of j×2 obtained by alternately removing frames in the same frame range. While being the same frame, costs are compared between an I frame in the former video sequence and an H frame in the latter video sequence. If the cost for the I frame is greater than for the H frame, the H frame is added to the bitstream generated by merging GOPs at the same temporal level as described above. The same process is iteratively performed. However, if the cost for the I frame is less than for the H frame, no H frame is added to the bitstream since the I frame does not need to be converted into the H frame.

The structure of a bitstream generated using the abovementioned process will now be described with reference to FIG. 8.

FIG. 8 shows the structure of an encoded bitstream according to an embodiment of the present invention.

Referring to FIG. 8, the encoded bitstream includes a sequence header 810 containing information about a video sequence and a plurality of GOP fields. Each GOP field is composed of a GOP header 820, encoded frames 830, and extra frames 840 to be used for merging GOPs when a temporal level (frame rate) varies.

The GOP header 820 contains various information about a GOP such as the number and resolution of encoded frames in the GOP. For example, GOP #2 may include a GOP #2 header 820-2 containing information indicating that the number of frames is 8. The number of encoded frames in a GOP obtained by merging GOPs is greater than that in an unmerged GOP. For example, if the latter is 8, the former may be 16 or 32.

The encoded frames 830 refer to quantized information obtained after removing temporal and spatial redundancies from frames in the video sequence. Each GOP may include only one I frame. As shown in FIG. 8, GOP #2 includes only one I frame followed by seven H frames.

The extra frames 840 refer to encoded H frames to be used for merging GOPs as a temporal level (frame rate) increases (decreases). Each of the extra frames 840 contains a flag indicating a temporal level. A transcoder checks the flag during transcoding and determines whether to truncate an extra frame or an I frame. The extra frame 840 may be located adjacent to a corresponding I frame because this eliminates the need to rearrange frames after selectively truncating the I frame or extra frame during transcoding.

A transcoder 760 shown in FIG. 7 truncates an unnecessary part of the encoded bitstream and outputs the remaining part. For example, when receiving a request for a bitstream of temporal level 1, the transcoder 760 truncates the extra frame 840 from the encoded bitstream and sends the remaining frames to a decoder (not shown).

Upon receipt of request for a bitstream of temporal level 2, the transcoder 760 alternately removes encoded frames 830. For example, the transcoder 760 truncates H frames #2, #4, #6, #8 that are among encoded frames 830-2. When there is an extra frame 840-2 corresponding to an I frame #1 as shown in FIG. 8, the transcoder 760 leaves the extra frame 840-2 by truncating the I frame #1. On the other hand, the transcoder 760 truncates an extra frame 840-3 in GOP #3 instead of a corresponding I frame. In this way, the number of I frames in a bitstream can be kept constant even if a frame rate decreases by half. When the bitstream contains the extra frame 840-2 by truncating the I frame #1, the GOP #2 header 820-2 may be deleted since GOPs are merged into each other. In this case, the number of frames specified in GOP #1 header 820-1 is corrected. Alternatively, the GOP #2 header 820-2 may not be deleted.

In this way, when there is a request for the bitstream of temporal level 2, either of I frames from two GOPs is replaced with an extra frame. Upon receipt of request for a bitstream of temporal level 3, three of four I frames from four GOPs are replaced with corresponding extra frames.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation. It is to be understood that various alterations, modifications and substitutions can be made therein without departing in any way from the spirit and scope of the present invention, as defined in the claims which follow.

According to the present invention, it is possible to achieve a scalable video coding method capable of efficiently encoding a video sequence into a bitstream with a variable GOP size.

1. A scalable video coding method comprising:
(a) receiving a video sequence;
(b) encoding the received video sequence into a first bitstream with a first Group of Pictures (GOP) size;
(c) encoding the received video sequence into a second bitstream with a second GOP size larger than the first GOP size; and
(d) comparing a first coding efficiency of the first bitstream and a second coding efficiency of the second bitstream, and determining one of the first bit stream and the second bitstream having better coding efficiency.

2. The method of claim 1, wherein (d) comprises:
comparing a first cost of the first bitstream and a second cost of the second bitstream; and
determining one of the first bitstream and the second bitstream having a lower cost.

3. The method of claim 2, wherein (d) comprises:
comparing a cost of an intraframe encoded with the first GOP size and a cost of an interframe obtained by encoding an original frame corresponding to the intraframe with the second GOP size; and
when the cost of the intraframe is less than the cost of the interframe, determining the first GOP size as a determined GOP size, while when the cost of the interframe is less than the cost of the interframe, determining the second GOP size as the determined GOP size.

4. The method of claim 1, further comprising generating extra frames by encoding a plurality of intraframes as a plurality of interframes and adding the generated extra frames to the bitstream.

5. The method of claim 4, wherein the extra frames added to the bitstream are located adjacent to the plurality of intraframes corresponding to the extra frames.

6. A scalable video encoder comprising:
a determiner adaptively determining a group of pictures (GOP) size according to a predetermined criterion; and
a scalable video coding unit encoding an input video sequence into a bitstream with the determined GOP size.

7. The encoder of claim 6, wherein the determiner adaptively determines one of a first GOP size and a second GOP size with a lower cost as the determined GOP size for a predetermined portion by comparing a first cost calculated when encoding a portion of the input video sequence with the first GOP size with a second cost calculated when encoding the portion of the input video sequence with the second GOP size larger than the first GOP size.

8. The encoder of claim 6, wherein the determiner compares a first cost of an intraframe obtained by encoding a portion of the input video sequence with the first GOP size and a second cost of an interframe obtained by encoding an original frame corresponding to the intraframe with the second GOP size, and determines the first GOP size as the determined GOP size for the encoded portion when the first cost of the intraframe is less than the second cost of the interframe or the second GOP size as the determined GOP size for the encoded portion when the first cost of the intraframe is greater than the second cost of the interframe.

9. The encoder of claim 6, wherein the scalable video coding unit generates extra frames by encoding original frames corresponding to a plurality of intraframes as a plurality of interframes and adds the generated extra frames to the bitstream.

10. The encoder of claim 9, wherein the scalable video coding unit arranges the extra frames into the bitstream so the extra frames are adjacent to the plurality of intraframes corresponding to the extra frames.

11. A bitstream with variable-sized GOPs, the bitstream comprising:
first video frames scalably encoded with a first group of pictures (GOP) size; and
second video frames scalably encoded with a second GOP size.

12. The bitstream of claim 11 further comprising generated extra frames obtained by encoding a plurality of intraframes as a plurality of interframes.

13. The bitstream of claim 12, wherein the generated extra frames are located adjacent to the plurality of intraframes corresponding to the extra frames.

14. The bitstream of claim 12, wherein the extra frames include a flag indicating a temporal level to be used.

15. A transcoding method comprising:
receiving a bitstream containing scalably encoded video frames and extra frames obtained by scalably encoding original frames corresponding to encoded intraframes in the scalably encoded video frames as interframes; and
selectively deleting the encoded intraframes and the extra frames corresponding to the intraframes.

16. The transcoding method of claim 15, wherein the selectively deleting is performed such that a proportion of the intraframes included in the bitstream is efficiently kept according to a change in a frame rate.

17. The transcoding method of claim 15, wherein the selectively deleting comprises checking a flag indicating a temporal level to be used during transcoding to determine whether to truncate an extra frame or an intraframe frame, and deleting the intraframe if the flag is identical with the temporal level or deleting the extra frame if the flag is different from the temporal level.

18. A recording medium having a computer-readable program recorded thereon for executing the method of scalable video coding, the method comprising:
(a) receiving a video sequence;
(b) encoding the received video sequence into a first bitstream with a first Group of Pictures (GOP) size;
(c) encoding the received video sequence into a second bitstream with a second GOP size larger than the first GOP size; and
(d) comparing a first coding efficiency of the first bitstream and a second coding efficiency of the second bitstream, and determining one of the first bitstream and the second bitstream having better coding efficiency.
